(19) United States
(12) Patent Application Publication
(10) Pub. No.: US 2002/0144270 A1
(43) Pub. Date: Oct. 3, 2002

(54) Recording and reproducing device and program list forming method thereof

(76) Inventors: Yuji Mizushiro, Ehime (JP); Yoichi Kondoh, Ehime (JP)

Correspondence Address: RATNER AND PRESTIA, Suite 301, One Westlakes, Berwyn, P.O. Box 980, Valley Forge, PA, 19482-0980, US

(21) Appl. No.: 10/067,387

(22) Filed: Feb. 5, 2002

(30) Foreign Application Priority Data
Feb. 5, 2001 (JP) 2001-027905

(51) Int. Cl. H04N 7/16; H04N 9/79; G06F 3/00; H04N 5/445; G06F 13/00; H04N 7/173

(52) U.S. Cl. 725/55; 725/30; 386/35; 725/124

(57) ABSTRACT

A recording and reproducing device comprising control input means to input password, password managing part to manage the inputted password, the first program list recording part from which is read only when the inputted password matches the password in password managing part, the second program list recording part from which is read when password is not inputted or when the inputted password is wrong, and program list forming means to form program list of desired program which is read form the first or the second program list recording part.

### FIELD OF THE INVENTION

The present invention relates to a recording and reproducing device with program list of program information having viewing restrictions and program list forming method thereof.

### BACKGROUND OF THE INVENTION

Conventionally, the following method has been proposed as we can see in JP Utility Model Publication No.H06-052025 in order to avoid another user to know the recorded contents easily. A user records the desired contents with a password. In this recording, concretely, recorded contents are converted to pseudo random data in accordance with each password. At the time of reproducing, a reverse process is performed in correspondence with the password.

Otherwise, JP Patent Publication No.H08-007475 discloses that a user is requested to input a password to prevent another user from reproducing the recorded contents freely, and that the reproducing operation against the loaded recording medium is controlled according to the result compared the inputted password with the registered one.

In the above referenced prior arts, though normal reproduction is impossible without a valid password, another user can reproduce and delete the recorded contents as well as watch easily the information of recorded programs (for example, title, day and time, length, etc. of the programs), when the plural users share the recording and reproducing device having the list of the recorded contents. Therefore, even if the device has a password input function, privacy problem has not been resolved as long as the recorded contents are indicated on a display.

### SUMMARY OF THE INVENTION

In a recording and reproducing device having a program list recording part to record program information which comprises control input means to input a password, password managing part to manage the password, and program list forming means to read from the program list recording part and to form program list, the program list recording part includes the first program list recording part of which program information is indicated only by inputting a valid password which matches the password managed in password managing part and the second program list recording part of which program information is indicated when a user does not input a password or when an inputted password is wrong.

### BRIEF DESCRIPTION OF THE DRAWINGS

FIG. 1 is a block diagram of recording and reproducing device in accordance with the first exemplary embodiment of the present invention.

FIG. 2 is a block diagram of recording and reproducing device in accordance with the second exemplary embodiment of the present invention.

FIG. 3 is a block diagram of recording and reproducing device in accordance with the third exemplary embodiment of the present invention.

### DETAILED DESCRIPTION OF THE INVENTION

(The First Embodiment)

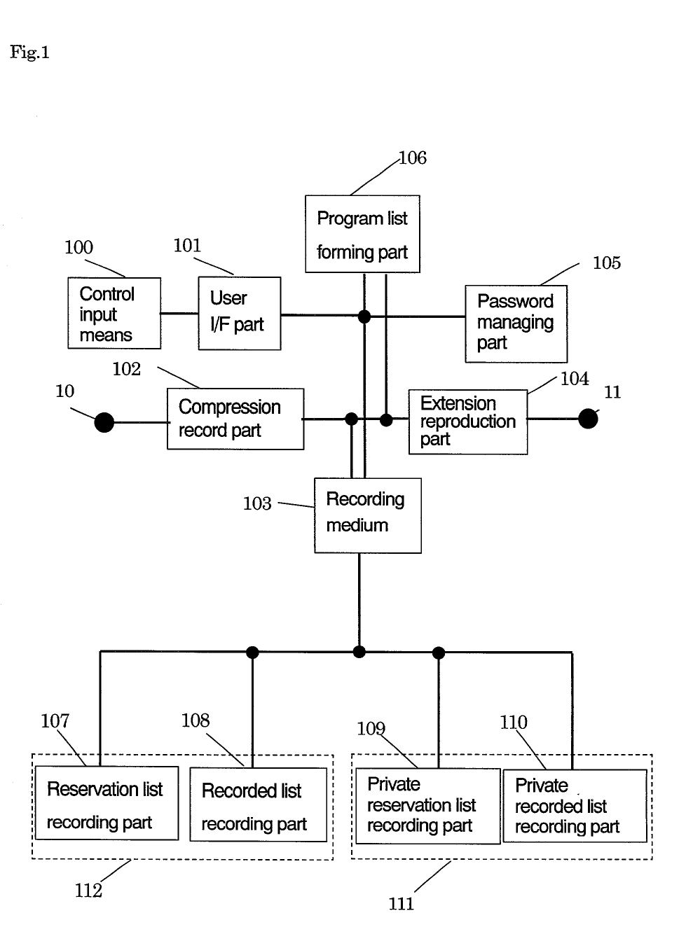

The first exemplary embodiment of the present invention is demonstrated hereinafter with reference to FIG. 1.

Recording audio and visual signal (hereinafter called AV signal) of television broadcasting is described in FIG. 1. AV signal of analog style applied to terminal 10 is compressed at compression record part 102 after digitalization. This compressed AV signal is sent to recording medium 103, and then recorded there. If an inputted signal is already digital style, it is just compressed and recorded at recording medium 103.

When reproducing, the compressed data from recording medium 103 is sent to extension reproduction part 104. After AV signal is extended and converted to signal of analog style, it is output from output terminal 11 to outside display unit like television monitors (not shown in FIG. 1).

Control input means 100 transmits a control signal to user interface part (hereinafter called user I/F part) 101 in order to control a recording and reproducing device. Usually, it is a remote control machinery (hereinafter called a remote controller). Besides a remote controller, a keyboard, a mouse, or a something like this can be also utilized. A user utilizes transmission channel which is cabled, wireless, light, etc. in order to control a recording and reproducing device. In other words, user I/F part 101 processes a control signal transmitted from outside device like remote controllers, and controls interface between outside device and a recording and reproducing device. Control input part other than a remote controller may be built in the main body of a recording and reproducing device

Now, the recording mode of program information is described here. There are two kinds of recording mode as follows. A user predetermines whether program information to be recorded in the first program list recording part or the second program list recording part by control input means 100. He/She may choose such recording mode after inputting password. Once a password is inputted to user I/F part 101 by control input means 100, it is compared with the registered password in password managing part 105. Only if the inputted password matches with the registered one (namely, it is a valid password), the program information is recorded into the first program list recording part 111 (hereinafter called the first recording mode). Then if a user does not input a password or the inputted password is wrong (namely it is an invalid password), the program information is recorded into the second program list recording part 112 (hereinafter called the second recording mode). Further, each program list recording part 111 and 112 has two recording area; one is for reservation and the other is for recorded. That is to say, reservation list recording part 107 and private reservation list recording part 109 are for reservation area, and recorded list recording part 108 and private recorded list recording part 110 are for recorded area. Here, “private” means it is not indicated without valid password.

Then, the indication mode of indicating the program list is described here. The alternative of the following three modes; the first indication mode, the second indication mode, the third indication mode can be set by control input means 100. In case of a valid password, two indication modes are provided. As to the first indication mode, program list read from only the program list recording part 111 is formed at program list forming part 106. Then, requested program list can be displayed on outside TV monitor, etc. Regarding the second indication mode, program list read from both recording part 111 and recording part 112 is formed at program list forming part 106, and then displayed.

While, in case of an invalid password, program list read from only the program list recording part 112 is formed at program list forming part 106. Then, requested program list can be displayed. This is the third indication mode.

Thus, when a user makes a recording reservation on the second recording mode by control input means 100, reserved program information including title, time, length, etc. of the program is recorded in reservation list recording part 107. And recorded program information is recorded in recorded list recording part 108.

Otherwise, when a user makes a recording reservation on the first recording mode by control input means 100, reserved program information is recorded in private reservation list recording part 109. And recorded program information is recorded in private recorded list recording part 110. Here, in both the first and second indication modes, a valid password inputted by a user enables him/her to see program list formed at program list forming part 106, that is read from private reservation list recording part 109 and private recorded list recording part 110.

As described above, after setting the first recording mode by control input means 100, a user can record a desired program information in the first program list recording part 111 that cannot be shown with an invalid password. This means that each user can easily set viewing restriction and that privacy can be protected. Therefore, the problem of reproducing and deleting program by another user is resolved successfully.

(The Second Embodiment)

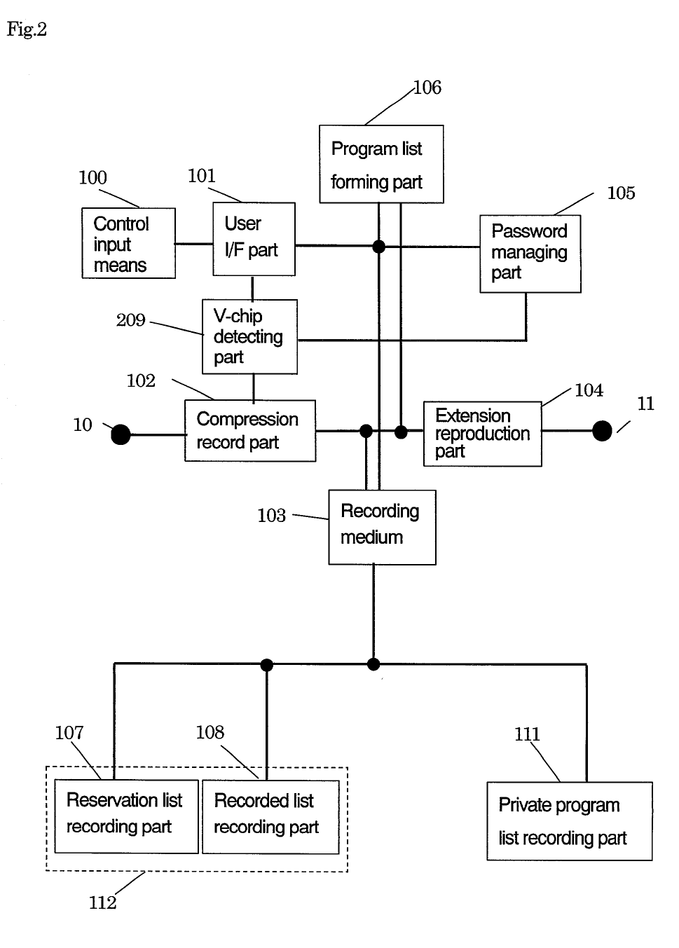

The second exemplary embodiment of the present invention is demonstrated hereinafter with reference to FIG. 2. Regarding the same constitution and operation as the invention presented in the first embodiment, detailed explanation is omitted and the same number as FIG. 1 is referred. The different part is mainly described here.

In FIG. 2, there are two different points from the first embodiment. One is adding V-chip detecting part 209. And the other is deleting the distinction between reservation list and recorded list in the first program list recording part 111, which means recording part 111 consists of only private program list recording part. However, the second program list recording part 112 comprises both reservation part 107 and recorded part 108 like the first embodiment.

In the V-chip system, ratings such as “violent” and “sexual” are respectively given to television programs, and the program to be broadcast accompanied by the rating information is sent out. Regarding the television broadcasting program having V-chip system, V-chip signal is incorporated into a vertical blanking interval of a video signal. The type of rating is defined by EIA (Electronic Industries Association) 744.

V-chip signal is a kind of viewing restrictions placed on programs, so that parents can choose to filter what their children see in order to protect children from violent or adult program effecting harmful. As to V-chip information indicated in EIA-744-A, several steps of viewing restrictions are set as follows; what is appropriate for all children, what is designed for children age 7 and above, what is suitable for all ages, what is inappropriate for children under 14, what is unsuitable for children under 17, and so on.

Firstly, reservation operation is described here. In making reservation, a user begins with setting recording mode and rating level by control input means 100. When a user chooses the first recording mode, program information is recorded in the first recording part 111, which is private. In order to indicate the program list, a password is requested. Then, a user chooses the second recording mode, program information is recorded in the reservation list recording part 107. He/she is not requested to input a password to watch the program list. However, reproducing program contents is controlled depending on the rating level in V-chip signal that he/she has set as the reservation operation.

Secondly, the case of the first recording mode is described here. Television broadcasting program information is recorded in the first program list recording part 111, which is private. The recorded program information in this private recording part 111 can be indicated when a user input a valid password managed in password managing part 105 by control input means 100. Then, the desired recorded contents can be reproduced. Namely, other user can neither reproduce the recorded program nor delete it, as he/she does not know the valid password. This means it is easy to set the viewing restriction to protect each privacy.

Lastly, the case of the second recording mode is described here. Television broadcasting program information is recorded in the second program list recording part 112. In making reservation, program information is recorded in reservation list recording part 107. Such recorded program list can be indicated free from a password. After being recorded, however, in order to reproduce the recorded contents in recording medium, reproduction operation is controlled in accordance with rating level in V-chip signal that has set as the reservation operation by control input means 100. When V-chip signal of the desired program is detected to be stricter than the predetermined rating level, reproduction operation is restricted. That is to say, the desired contents cannot be reproduced.

In the second recording mode, when rating level of the desired program is stricter than the predetermined level, the program information can be changed to be recorded in the private program list recording part 111. While, even in the first recording mode, as long as rating level of the desired program is not stricter than the predetermined level, a user can change to record the desired program to the second recording part 108. Namely, it is possible to arrange the program list that is according to rating level. In other words, in the second recording mode, program information can be controlled whether to be recorded in the first recording part 111 or the second recording part 108 in accordance with rating level detected in V-chip signal.

As described above, a case of television broadcasting is described in this second exemplary embodiment. However, similar effect can be also obtained in some package media such as DVD soft and VTR soft that viewing restriction is set on. Thus, privacy can be protected.

(The Third Embodiment)

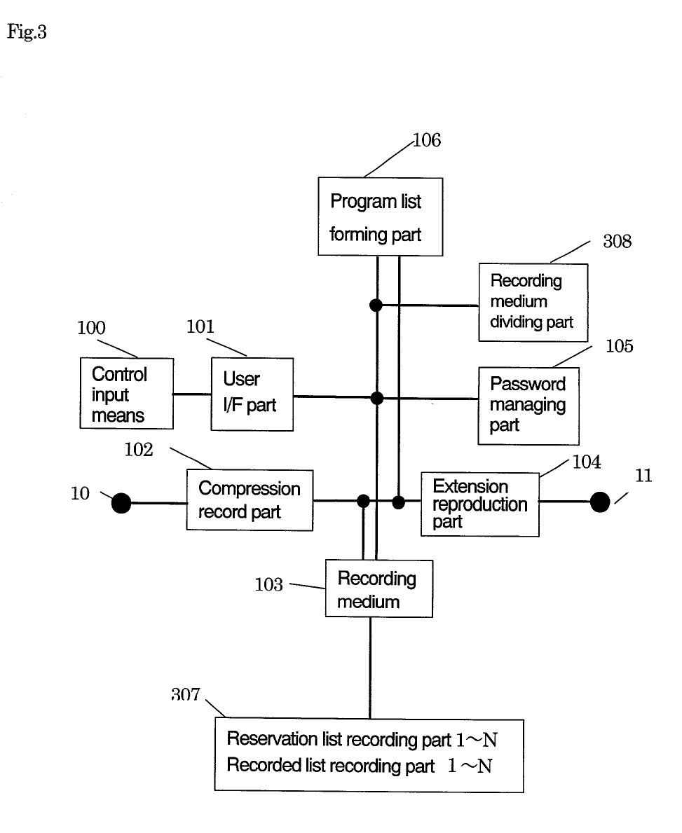

The third exemplary embodiment of the present invention is demonstrated hereinafter with reference to FIG. 3. Regarding the same constitution and operation as the invention presented in the first embodiment, detailed explanation is omitted and the same number as FIG. 1 is referred. The different part is mainly described here.

In FIG. 3, there are two points different from the first embodiment. One is adding recording medium dividing part 308 that is managing the record area in recording medium. The other is dividing recording medium 103 into some record area and preparing program list recording part 307 that has both recorded program list and recording reservation list corresponding with each divided record area, and still, passwords corresponding with each divided area is set. When a user wants to watch the recorded program information in recording part 307 including recorded list and reservation list in each area, he/she inputs a valid password corresponding with each area that is managed at password managing part 105. Then, corresponding list of the desired program information is formed at program list forming part 106 and displayed on TV monitor, etc. as he/she can watch.

Recording medium dividing part 308 divides the recording medium 103 into arbitrary number of record area by way of user I/F by user's setting at control input means 100. A user can change setting regarding number and capacity of dividing area at this dividing part 308. In accordance with division at dividing part 308, recorded program list 1˜N and recording reservation list 1˜N that are corresponding with the number of divided record area are prepared. Each record area has corresponding list respectively. Program information is recorded in only corresponding record area. A user can choose the desired one among recorded program list 1˜N and recording reservation list 1˜N by inputting password managed at password managing part 105 by way of control input means 100. In reproducing, program list is read from the record area in recording medium 103 corresponding with input valid password and formed at the program list forming part 106. As the result, chosen program list can be indicated and desired contents can be reproduced.

As written above, by dividing recording medium 103 into plural and having each list in every divided area, the problem of reproducing and deleting program by another user is disappeared successfully. Thus, privacy can be protected.

Further, at control input means 100, it is possible to set password free area in dividing recording medium 103 into arbitrary number of record area. Password free area means accessible record area without password. In such password free area, anyone can see the program list and reproduce desired contents.

Although the present invention has been described in terms of various embodiments, it is not intended that the invention be limited to these embodiments. Modification within the spirit of the invention will be apparent those skilled in the art.

What is claimed is:

1. A recording and reproducing device having a program list recording part to record program information, comprising:
(a) a control input means to input a password;
(b) a password managing part to manage said password; and,
(c) a program list forming means to read from said program list recording part and to form program list;
wherein said program list recording part includes the first program list recording part of which program information is indicated only by inputting a valid password which matches the password managed in password managing part and the second program list recording part of which program information is indicated when a user does not input a password or when an inputted password is wrong.

2. The recording and reproducing device of claim 1, wherein two indication modes are provided in valid password;
(a) the first indication mode in which program list is read from the first recording part and indicated; and,
(b) the second indication mode in which program list is read from both first and second recording part and indicated.

3. The recording and reproducing device of claim 2, wherein indication mode of program information list is changed by the control input means.

4. The recording and reproducing device of claim 1, wherein the program information is determined whether to be recorded in the first recording part or to be recorded in the second recording part by the control input means.

5. A recording and reproducing device having plural program list recording parts to record program information of television broadcasting contents, comprising:
(a) a password managing part to manage a password;
(b) a control input means to input said password;
(c) a recording medium dividing part to divide a recording medium by inputting the number of dividing record area in said control input means; and,
(d) a program list forming part to read from said program list recording part correspondent with divided record area and to form program list,
wherein program information is read from said program list recording part correspondent with record area, and program list is formed when inputted password by said control input means matches password correspondent with record area managed in said password managing part.

6. The recording and reproducing device of claim 5, wherein said divided record area of recording medium comprises two kinds of program list recording parts; one recording part of which program information is indicated only by inputting valid password which matches the password that is correspondent with record area and is managed in said password managing part, and another recording part of which program information is indicated when a user does not input password or when inputted password is wrong.

7. The recording and reproducing device of claim 5, wherein said divided record area of recording medium includes password free area that anyone can access to see program list and reproduce desired contents without password.

8. The recording and reproducing device of claim 1, claim 3, claim 4, or claim 6, wherein said program list includes reservation list indicating program information setting reservation and recorded program list indicating recorded program information.

9. The recording and reproducing device of claim 1, claim 3, claim 4, or claim 6, wherein choosing a program in program list read from program list recording part enables contents of said desired program to be reproduced or deleted from recording medium.

10. The recording and reproducing device of claim 1 comprises V-chip signal detecting part to detect V-chip signal in television broadcasting, wherein said V-chip signal detected in said V-chip detecting part controls television broadcasting program information to be recorded in the first program list recording part or the second program list recording part.

11. The recording and reproducing device of claim 10, wherein rating level of V-chip system is determined by said control input means.

12. The recording and reproducing device of claim 10 comprises steps of;
(a) detecting rating level in V-chip signal of AV signal;
(b) comparing with said predetermined rating level; and,
(c) recording program information in the first program list recording part when V-chip signal of the desired program is detected to be stricter than said predetermined rating level.

13. The recording and reproducing device of claim 10, wherein television broadcasting program information is recorded in the first program list recording part only when viewing restriction in V-chip signal is detected in said V-chip signal detecting part.

14. A method of forming program list of recording and reproducing device having plural program list recording parts to record program information of television broadcasting contents, and having said program list including reservation list to record reservation program information and recorded list to record recorded program information, comprising the step of:
(a) inputting a password;
(b) comparing said inputted password with password managed in password managing part of recording and reproducing device; and,
(c) forming program list from said plural program list recording part only when said inputted password matches password managed in password managing part.

15. A method of forming program list of recording and reproducing device having plural program list recording parts to record program information of television broadcasting contents, comprising the step of:
(a) inputting a password by control input means;
(b) comparing said inputted password with password managed in password managing part of recording and reproducing device; and,
(c) choosing recording part by said control input means either the first program list recording part from which is read only when inputted password matches password managed in password managing part or the second program list recording part from which is read when password is not inputted or when inputted password is wrong.
